(19) United States
(12) Patent Application Publication
(10) Pub. No.: US 2011/0102599 A1
(43) Pub. Date: May 5, 2011

(54) MOBILE TERMINAL INCLUDING PROJECTOR AND CONTROL METHOD THEREOF

(75) Inventors: Jin-Wook KWON, Suwon-si (KR); Mun-Kue Park, Suwon-si (KR); Jung-Kee Lee, Osan-si (KR); Seong-Taek Hwang, Pyeongtaek-si (KR); Mu-Sik Kwon, Seoul (KR); Joung-Min Seo, Seoul (KR)

(73) Assignee: Samsung Electronics Co., Ltd., Suwon-si (KR)

(21) Appl. No.: 12/914,542

(22) Filed: Oct. 28, 2010

(30) Foreign Application Priority Data
Oct. 29, 2009 (KR) 10-2009-0103661

(51) Int. Cl. H04N 5/33

(52) U.S. Cl. 348/164

(57) ABSTRACT

Disclosed is a mobile terminal for providing a blackboard function to an image projected through a projector, which includes a projector for projecting an image on a screen, a camera for photographing the image projected through the projector and transferring the photographed image to an image processor. The image processor processes the image transferred from the camera and transfers the processed image to a controller. The controller controls the operation of the mobile terminal including recognizing an effective region for the projected image where infrared rays are detected from the photographed image so as to recognize an indication position of an indication device. The indication device generates infrared rays, in the projected image, and when the infrared rays are detected, a preset mark is displayed on a position of the detected infrared rays by using the projector.

### PRIORITY

This application claims priority under 35 U.S.C. §119(a) to a Korean Patent Application entitled “Mobile Terminal Including Projector And Control Method Thereof” filed in the Korean Industrial Property Office on Oct. 29, 2009 and assigned Serial No. 10-2009-0103661, the contents of which are incorporated herein by reference.

### BACKGROUND OF THE INVENTION

1. Field of the Invention

The present invention relates generally to a mobile terminal, such as a mobile phone and a smart phone, and more particularly, to a mobile terminal, which includes a projector providing a projection function, and a control method of the mobile terminal.

2. Description of the Related Art

A conventional mobile phone employs only an inside or an external Liquid Crystal Display (LCD) serving as a display means according to a type of the mobile phone, such as a folder-type or a slide type. However, a TV-out function can provide a larger screen size and can display information of a mobile communication terminal on an external display device, such as the connection with an external projector through a connector have been recently developed for the mobile communication terminal.

Further, a compact projector module has recently been mounted on the mobile communication terminal, so that it is possible to expand a function of a display unit by using the projector for entertainment and business, in addition to a basic display, such as the LCD of the mobile communication terminal, and to share information of a mobile phone of an individual with people at the same time. Therefore, for example, work of a businessman or a class presentation of a student, can be conveniently presented through a motion picture and/or other presentation materials stored in the mobile communication terminal by using the projector of the mobile communication terminal, without the complicated installation of the projector.

In the meantime, while performing the general presentation, it is possible to move a pointer or control a screen of a presentation by using a mouse in a separate PC. However, because the separate PC or the mouse is not present in the performance of the presentation using the projector of the mobile communication terminal, it is not easy to move the pointer while giving a presentation in front of the presentation screen. Therefore, there is required a means capable of easily indicating a part to be explained for the user during the performance of the presentation by using the projector of the mobile communication terminal.

### SUMMARY OF THE INVENTION

Accordingly, the present invention has been made to solve the above-stated problems occurring in the prior art, and the present invention provides an apparatus and a method for providing a blackboard function, which enables a user to use a screen like a blackboard by using a separate indication device in performing the presentation using a mobile terminal including a projector.

In accordance with an aspect of the present invention, there is provided a mobile terminal for providing a blackboard function, including a projector projecting an image on a screen; a camera for photographing the image projected through the projector and transferring the photographed image to an image processor; an image processor for processing the image transferred from the camera and transferring the processed image to a controller; and the controller for making a control such that infrared rays are detected from the photographed image so as to recognize an indication position of an indication device, which generates infrared rays, in the projected image, and when the infrared rays are detected, a preset mark is displayed on a position of the detected infrared rays by using the projector.

In accordance with another aspect of the present invention, there is provided a method for providing a blackboard function to an image projected through a projector in a mobile terminal, the method including projecting an image through the projector of the mobile terminal; photographing the projected image by a camera of the mobile terminal; detecting infrared rays from the photographed image so as to recognize an indication position of an indication device generating infrared rays in the projected image; and, when the infrared rays have been detected from the photographed image, displaying a preset mark at a position, in which the infrared rays are detected, through the projector.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram schematically illustrating the construction of a mobile terminal including a projector for performing a blackboard function according to an embodiment of the present invention;

FIG. 2 is a graph illustrating a transmissivity according to a wavelength of a 2-band filter of a camera included in a mobile terminal including a projector according to an embodiment of the present invention;

FIG. 3 is a block diagram illustrating the construction of a mobile terminal including a projector according to an embodiment of the present invention;

FIG. 4 is a flowchart illustrating an operation of a blackboard function in a mobile terminal including a projector according to an embodiment of the present invention; and

FIG. 5 is a diagram illustrating the construction of an electronic pen usable in performing a blackboard function in a mobile terminal including a projector according to an embodiment of the present invention.

### DETAILED DESCRIPTION OF EMBODIMENTS OF THE PRESENT INVENTION

Hereinafter, embodiments of the present invention will be described with reference to the accompanying drawings. In the following description, the same elements will be designated by the same reference numerals although they are shown in different drawings. Further, various specific definitions found in the following description are provided only to help general understanding of the present invention, and it will be understood by those skilled in the art that various changes in form and details may be made therein without departing from the spirit and scope of the invention. In the following description of the present invention, a detailed description of known functions and configurations incorporated herein is omitted to avoid making the subject matter of the present invention unclear.

The present invention provides a method for implementing a function similar to a blackboard in a mobile terminal. In order to perform a function similar to a blackboard by using a separate electronic pen within an image projected through a projector in a mobile terminal including a projector module, when a user writes a letter or draws a figure on the projected image by using the electronic pen generating infrared rays, the camera of the mobile terminal photographs the projected image and analyzes the photographed image, recognizes a position of the written character or the drawn picture of the user, and displays the recognized position through the projector. To this end, the mobile terminal includes a camera with a 2-band filter that recognizes two wavelength regions so as to recognize infrared rays generated from a pen, which employs an infrared Light Emitting Diode (LED) as a light emitting body. Hereinafter, the present invention will be described with reference to the accompanied drawings in more detail.

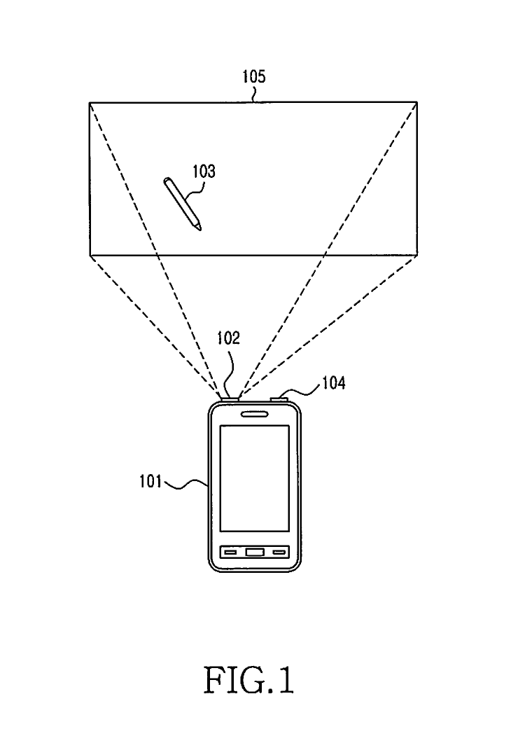

FIG. 1 is a diagram schematically illustrating the construction of a mobile terminal including a projector for performing a blackboard function according to an embodiment of the present invention. According to the present invention with reference to FIG. 1, the mobile terminal 101 including a compact projector module 102 projects an image through the projector 102. When a user writes a letter or draws a picture on a projected screen 105 by using an electronic pen 103 outputting infrared rays, a camera 104 of the mobile terminal 101 photographs the screen 105 projected through the projector 102, analyzes a photographed image, and recognizes an infrared signal outputted from the electronic pen 103. Then, the mobile terminal 101 displays a position of the recognized infrared signal through the projector 102. The user can use the blackboard function by writing a letter or drawing a picture on a position adjacent to the projected image or directly on the projected image by using the electronic pen 103. However, when the electronic pen 103 is set to generate the infrared rays over a predetermined distance in a straight line, the electronic pen 103 can generate infrared rays in a position separated from the image in a specific distance, so that the user can use the blackboard function.

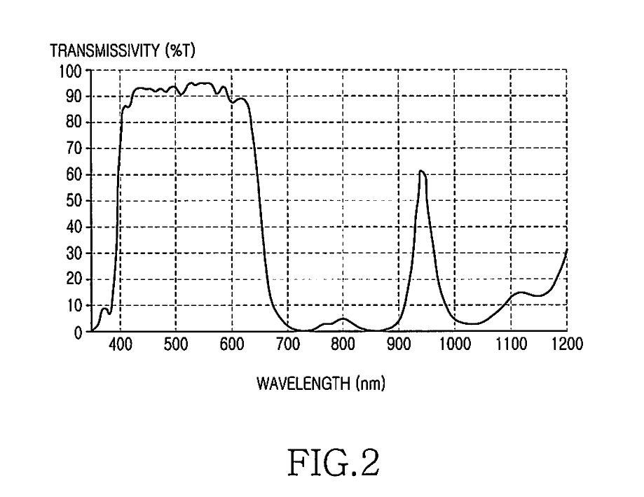

FIG. 2 is a graph illustrating transmissivity according to a wavelength of a 2-band filter of the camera included in the mobile terminal including the projector according to an embodiment of the present invention. The camera mounted on the mobile terminal according to the embodiment of the present invention includes a filter, which detects two wavelength regions including a visible light region and an infrared ray region and is attached to a lens of the camera. That is, as illustrated in FIG. 2, the 2-band filter for projecting the visible light region of 400˜700 nm, which is the region for photographing an expression in natural colors, and the infrared region of 900˜1,000 nm, which is the region for recognizing a signal displayed by an indication device of the electronic pen, is attached in front of the lens of the camera.

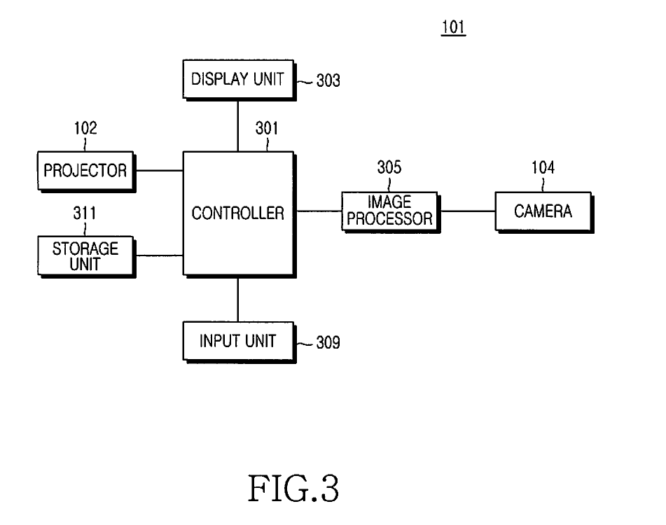

FIG. 3 is a block diagram illustrating the construction of the mobile terminal including the projector according to an embodiment of the present invention. Referring to FIG. 3, the mobile terminal including the projector according to the embodiment of the present invention includes the projector 102, the camera 104, an image processor 305, a controller 301, a display unit 303, an input unit 309, and a storage unit 311. The controller 301 can be implemented with an application processor, and the image processor 305 can be implemented with an image control IC.

The projector 102 is included in the mobile terminal, and enlarges and projects an image that the user desires to display on a screen, such as an external screen or a white wall surface.

The camera 104 includes the lens and an image sensor and photographs an image. The camera 104, according to the embodiment of the present invention, is mounted on the mobile terminal so as to photograph an image in an identical direction to that projected from the projector 102, and photographs the image projected through the projector 102 and obtains image information during the operation of the projector 102 and transfers the obtained image information to the image processor 305. Further, the 2-band filter is attached to a front surface of the lens of the camera 104 in order to detect the visible light and the infrared rays, so that the camera 104 photographs the infrared signal outputted on the image projected through the projector 102 by the electronic pen 130.

Further, the camera 104 can photograph an image by using the lens attached in a front surface of the mobile terminal and preferably includes a hinge structure capable of moving a photographing direction of the camera 104 from a front direction to a side direction of the mobile terminal.

The image processor 305 receives the image photographed by the camera 104 and converts the received image to a digital signal, and processes an image signal so as to display the image in accordance with a standard of each of the display unit 303 and the projector 102 and transfers the processed image signal to the controller 301.

The controller 301 controls the general operation of the mobile terminal and a signal flow between each of the elements of the mobile terminal. The controller 301 outputs a control signal to the image processor 305 so as to display the image in accordance with the standard of each of the display unit 303 and the projector 102. The controller 301, according to the embodiment of the present invention, can be implemented with a Mobile Station Modem (MSM) series Integrated Circuit (IC) an Application Processor (AP) chip, an exclusive graphic IC, or the like. The controller 301 recognizes only a region projected by the projector 102 among the photographed image received from the image processor 305 as an effective region, and processes a region not projected through the projector 102 in the photographed image as an ineffective region. That is, the controller 301 sets only the region projected through the projector 102 as the effective region of the blackboard, so that it detects an infrared signal only within the effective region.

A size of the image projected through the projector 102 may be varied according to a distance between the screen and the mobile terminal. Where the mobile terminal is close to the screen, the size of the image projected through the projector 102 becomes small, and where the mobile terminal is far from the screen, the size of the image projected through the projector 102 becomes large. The size of the image projected through the projector 102 is the size of the blackboard performing the blackboard function.

The controller 301 inspects the effective region and detects the infrared signal. When the user generates infrared light within the image projected on the screen, i.e. the region of the blackboard, by using the electronic pen including the infrared light emitting body, the controller 301 detects the infrared signal from the image photographed by the camera 104, and displays a part indicated by the electronic pen with a mouse pointer or a specific mark, such as an easily recognizable figure including a pointer, a brush shape, an icon, and/or a pattern, at a position of the detected infrared signal on the screen. The mouse pointer or the mark can be varied according to a setting of the user.

The display unit 303 can be implemented with an LCD panel. When the LCD panel is implemented in a form of a touch screen, the display unit 303 serves as an input means. The display unit 303 displays information inputted by the user or information to be provided to the user, as well as various menus of the mobile terminal. Especially, the display unit 303 displays a menu according to the operation of the projector 102, and can display an image identical to that displayed through the projector 102. When the display unit 303 displays the image identical to that displayed through the projector 102, there is an effect in that the display unit 303 can display the image, without the concern of the performance burden of the controller 301.

The input unit 309 receives an input of the user and transmits the user input to the controller 301.

The storage unit 311 stores data necessary for the operation of the mobile terminal. Further, the storage unit 311, according to the embodiment of the present invention, can store data to be projected through the projector 102.

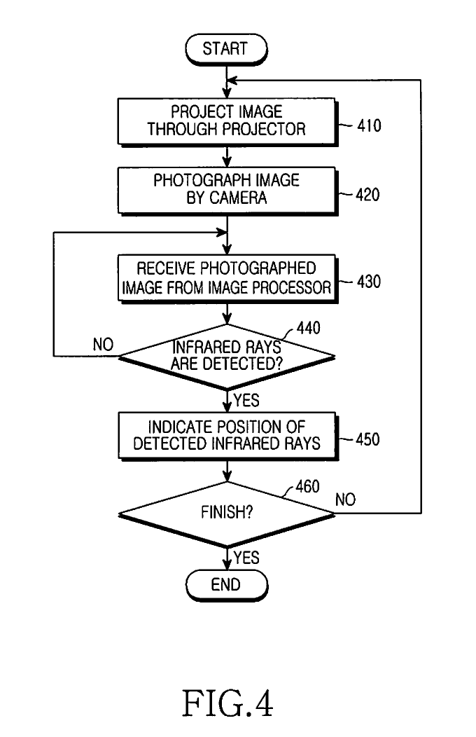

FIG. 4 is a flowchart illustrating an operation of the blackboard function in the mobile terminal including the projector according to an embodiment of the present invention. Referring to FIG. 4, the mobile terminal projects an image through the projector in step 410. The camera photographs the projected image in step 420, and transfers the photographed image to the image processor in step 430. The controller receives data of the photographed image from the image processor and detects infrared rays from the received image data in step 440. When the infrared rays are not detected from the received image data in step 440, the controller returns to step 430 and continuously receives a photographed image. When the infrared rays have been detected from the received image data in step 440, the controller displays a mark, such as a mouse pointer, at a spot (position) of the detected infrared rays in step 450. When the operation of the mobile terminal is not terminated in step 460, it proceeds to step 410 and continues the subsequent steps. However, when the operation of the mobile terminal is terminated in step 460, the operation for providing the projection function is completed.

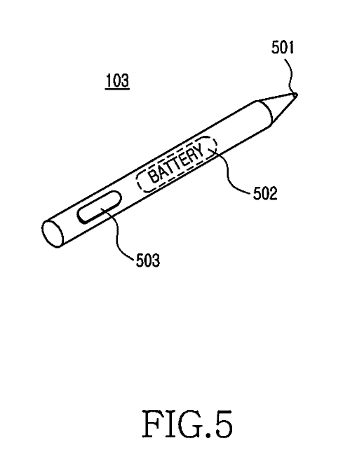

FIG. 5 is a diagram illustrating the construction of the electronic pen usable in performing the blackboard function in the mobile terminal including the projector according to an embodiment of the present invention. Referring to FIG. 5, the electronic pen 103 according to the embodiment of the present invention includes an infrared LED 501 for generating infrared light, a battery 502 for driving the electronic pen 103, and a switch 503 for turning on and off the infrared LED in the electronic pen 103. The infrared LED 501 can generate infrared light in a preset distance in a straight line. The switch 503 can be positioned on an upper end of the electronic pen, as illustrated in FIG. 5, but may be positioned on a lower end portion of the pen or on a penpoint portion.

Accordingly, the present invention has an effect in that the user of the mobile terminal can display the position indicated by the separate electronic pen on the projected image by using the mobile terminal including the projector in the performance of the presentation, and use a wall surface or a screen in size equivalent to the size of the projected image, like the blackboard, thereby providing a simple presentation or lecture.

Further, the present invention can respond to the user's action displayed on the large screen by the projector, as well as display information only for the user of the mobile terminal including the projector.

Therefore, as described above, it is possible to implement the construction and the operation of the mobile terminal including the projector and the control method of the mobile terminal according to the embodiments of the present invention described above. While the present invention has been shown and described with reference to certain embodiments and drawings thereof, it will be understood by those skilled in the art that various changes in form and details may be made therein without departing from the spirit and scope of the invention as defined by the appended claims.

What is claimed is:

1. A mobile terminal for providing a blackboard function, comprising:
a projector projecting an image on a screen;
a camera for photographing the image projected through the projector and transferring the photographed image to an image processor;
the image processor for processing the image transferred from the camera and transferring the processed image to a controller; and
the controller for detecting infrared rays from the photographed image so as to recognize an indication position of an indication device, which generates the infrared rays, in the projected image, and when the infrared rays are detected, displaying a preset mark on a position of the detected infrared rays by using the projector.

2. The mobile terminal as claimed in claim 1, wherein the camera is mounted on the mobile terminal so as to photograph an image in a direction identical to a direction in which the projector projects an image.

3. The mobile terminal as claimed in claim 1, wherein the camera photographs an image by using a 2-band filter, which detects visible light and infrared rays.

4. The mobile terminal as claimed in claim 1, wherein the controller sets a region projected by the projector in the photographed image as an effective region and detects infrared rays only within the effective region.

5. The mobile terminal as claimed in claim 1, wherein the preset mark includes a mouse pointer or a specific figure, and is changed and displayed according to a setting of a user.

6. The mobile terminal as claimed in claim 1, wherein the camera is mounted on a front surface of the mobile terminal and enables to change a photographing direction of the camera from a front direction to a side direction of the mobile terminal.

7. The mobile terminal as claimed in claim 1, wherein the indication device generating infrared rays is an electronic pen generating infrared light by using an infrared light emitting diode.

8. A method for providing a blackboard function to an image projected through a projector in a mobile terminal, the method comprising the steps of:
projecting an image through the projector of the mobile terminal;
photographing the projected image by a camera of the mobile terminal;
detecting infrared rays from the photographed image so as to recognize an indication position of an indication device generating infrared rays in the projected image; and
when the infrared rays have been detected from the photographed image, displaying a preset mark at a position, in which the infrared rays are detected, through the projector.

9. The method as claimed in claim 8, wherein in photographing the projected image by a camera of the mobile terminal, the camera of the mobile terminal photographs the image in a direction identical to a direction in which the image is projected.

10. The method as claimed in claim 8, wherein in photographing the projected image by the camera of the mobile terminal, the camera of the mobile terminal photographs the projected image by using a 2-band filter, which detects visible light and infraredrays.

11. The method as claimed in claim 8, wherein detecting the infrared rays from the photographed image by a controller of the mobile terminal comprises:
setting only a region projected by the projector among the photographed image as an effective region; and
detecting infrared rays from the effective region.

12. The method as claimed in claim 8, wherein the preset mark includes a mouse pointer or a specific figure, and is changed and displayed according to a setting of a user.

13. The method as claimed in claim 8, wherein the indication device generating the infrared rays is an electronic pen generating infrared light by using an infrared light emitting diode.
